(19) United States
(12) Patent Application Publication
(10) Pub. No.: US 2023/0004870 A1
(43) Pub. Date: Jan. 5, 2023

(54) MACHINE LEARNING MODEL DETERMINATION SYSTEM AND MACHINE LEARNING MODEL DETERMINATION METHOD

(71) Applicant: Kabushiki Kaisha Yaskawa Denki, Kitakyushu-shi (JP)

(72) Inventors: Masaru ADACHI, Kitakyushu-shi (JP); Tsuyoshi YOKOYA, Kitakyushu-shi (JP); Ryo MASUMURA, Kitakyushu-shi (JP)

(21) Appl. No.: 17/941,033

(22) Filed: Sep. 9, 2022

Related U.S. Application Data
(63) Continuation of application No. PCT/JP2020/010804, filed on Mar. 12, 2020.

(51) Int. Cl. G06N 20/00

(52) U.S. Cl. CPC G06N 20/00

(57) ABSTRACT

Provided is a machine learning model determination system including: at least one server and at least one client terminal; an evaluation information database which stores evaluation information being information on an evaluation of machine learning; an evaluation information update module which updates the evaluation information based on a specific value of a parameter and an evaluation of the machine learning through use of specific teaching data; a teaching data input module; a verification data input module; a parameter determination module which determines the specific value of the parameter based on the evaluation information; and a machine learning engine which includes a learning module which executes learning for a machine learning model through use of the specific teaching data, and an evaluation module which evaluates a result of the machine learning through use of the specific verification data.

### CROSS-REFERENCE TO RELATED APPLICATION

The present disclosure contains subject matter related to that disclosed in International Patent Application PCT/JP2020/010804 filed in the Japan Patent Office on Mar. 12, 2020, the entire contents of which are hereby incorporated by reference.

### BACKGROUND OF THE INVENTION

### 1. Field of the Invention

The embodiments disclosed herein relates to a machine learning model determination method and a machine learning model determination system.

### 2. Description of the Related Art

In JP 2019-79214 A, there is described a search apparatus which searches for hyperparameter values for machine learning. In the search apparatus as described in JP 2019-79214, new hyperparameter values can be selected by various methods, such as a method of randomly selecting new hyperparameter values from a hyperparameter space, a method of selecting new hyperparameter values so that the new hyperparameter values selected from the hyperparameter space are arranged in a grid form, and a method of narrowing down hyperparameter values to be selected through use of a property that models having prediction performances close to one another are generated from continuous hyperparameter predicted values close to one another (paragraph 0104).

### SUMMARY OF THE INVENTION

According to one aspect of the present invention, there is provided a machine learning model determination system including: at least one server and at least one client terminal which are connected to an information communication network, and are enabled to perform mutual information communication; an evaluation information database which is included in the at least one server, and is configured to store evaluation information being information on an evaluation of a learning result of machine learning for a value of the parameter, the parameter influencing the learning result of the machine learning; an evaluation information update module which is included in the at least one server, and is configured to update the evaluation information based on a specific value of the parameter and an evaluation of a learning result of the machine learning through use of specific teaching data; a teaching data input module which is included in the at least one client terminal, and is configured to input the specific teaching data; a verification data input module which is included in the at least one client terminal, and is configured to input specific verification data; a parameter determination module configured to determine the specific value of the parameter based on the evaluation information on the machine learning to be executed; and a machine learning engine which includes a learning module configured to execute learning for a machine learning model formed based on the specific value of the parameter through use of the specific teaching data, and an evaluation module configured to evaluate, through use of the specific verification data, a learning result of the machine learning of the learned machine learning model.

Further, according to one aspect of the present invention, there is provided a machine learning model determination method to be performed through an information communication network, the machine learning model determination method including: determining a specific value of a parameter based on evaluation information which is evaluation information on machine learning which is to be executed, and is information on an evaluation of a learning result of machine learning for a value of the parameter, the parameter influencing the learning result of the machine learning; forming a machine learning model based on the specific value of the parameter; executing learning of the machine learning model through use of specific teaching data; evaluating a learning result of the machine learning of the learned machine learning model through use of specific verification data; and updating the evaluation information based on the specific value of the parameter and the evaluation of the learning result of the machine learning.

### BRIEF DESCRIPTION OF THE DRAWINGS

It is generally difficult to appropriately design various parameters in machine learning including so-called hyperparameters. Even when parameters are searched for in a parameter space in order to eliminate uncertainly caused by dependency on intuition and experience of experts, the parameter space to be searched is vast, and hence an enormous amount of computing resources are required in order to search the entire parameter space, which is not realistic.

A preferred embodiment of the present invention described below will show how to appropriately determine machine learning parameters by efficiently using computing resources.

FIG. 1 is a schematic diagram for illustrating an overall configuration of a machine learning model determination system according to the preferred embodiment of the present invention.

FIG. 2 is a diagram for illustrating an example of a hardware configuration of each of a server and a client terminal.

FIG. 3 is a functional block diagram for illustrating principal components of a machine learning model determination system according to the preferred embodiment of the present invention.

FIG. 4 is a diagram for illustrating a flow of a schematic operation of the machine learning model determination system according to the preferred embodiment of the present invention.

FIG. 5 is a table for showing an example of conditions input to a condition input module by a user and templates defined in accordance with the conditions.

FIG. 6 is a schematic diagram for illustrating processing executed in Step S107 to Step S111 of the flow of FIG. 4 in line with machine learning models to be built.

FIG. 7 are graphs for showing a specific implementation example of determination of a specific value of a parameter.

FIG. 8 are schematic graphs for showing an example of an update of a probability density function.

FIG. 9 are schematic graphs for showing an example of an update of evaluation information for a parameter having a discrete property.

FIG. 10 are graphs for showing a determination method for specific values of a parameter.

FIG. 11 are graphs for showing a method of determining specific values of a parameter which have not been used for the machine learning, or have been used relatively less frequently for the machine learning.

FIG. 12 is a functional block diagram for illustrating a schematic configuration of the server having a configuration for solely updating the evaluation information.

### DESCRIPTION OF THE EMBODIMENTS

Description is now given of a machine learning model determination method and a machine learning model determination system according to a preferred embodiment of the present invention with reference to the drawings.

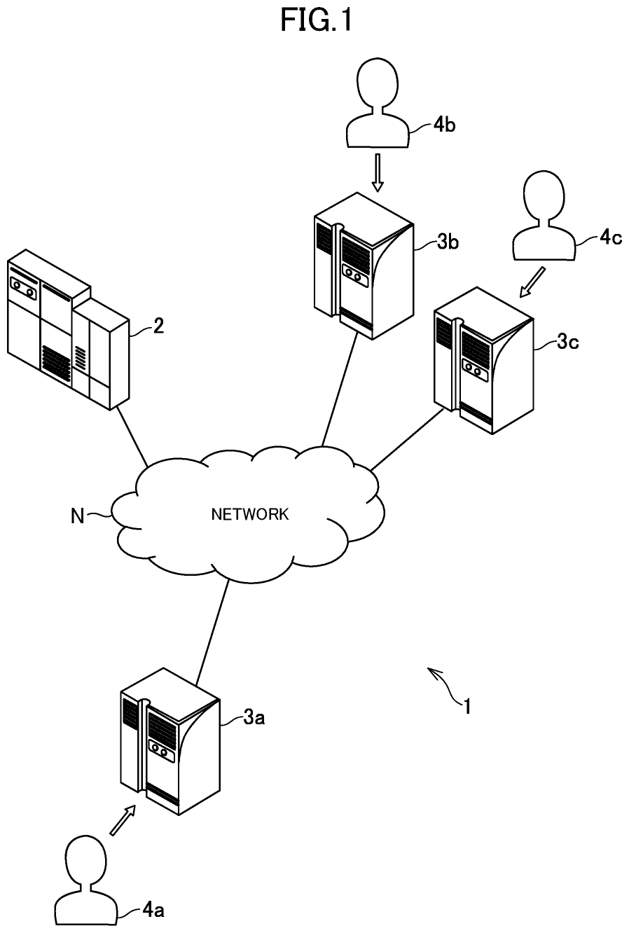

FIG. 1 is a schematic diagram for illustrating an overall configuration of a machine learning model determination system 1 according to the preferred embodiment of the present invention. In the machine learning model determination system 1, a server 2 and client terminals 3 (three client terminals 3 are illustrated in the figure, and suffixes “a,” “b,” and “c” are added when those client terminals 3 are distinguished from one another) being computers are connected to one another for information communication through a telecommunication network N.

The telecommunication network N is not particularly limited as long as a plurality of computers can communicate to/from one another through the telecommunication network N, and may be an open network such as the so-called Internet, or a closed network such as an enterprise network. Whether the telecommunication network N is wireless or wired or what communication protocol is used are not limited.

The server 2 executes management of various databases and the like as described later. The client terminals 3 in this example are computers scheduled to execute calculation through machine learning based on a method such as so-called deep learning. As each client terminal 3, a computer having a sufficient calculation performance for a target application is prepared.

Moreover, in each client terminal 3, information processing through machine learning is scheduled to be independently executed. In this case, there is assumed such a situation that users 4 (three users 4 are illustrated in the figure, and suffixes “a,” “b,” and “c” are added when those users 4 are distinguished from one another) who require the information processing through machine learning each install the client terminal 3 that suits this information processing, prepare teaching data required for the machine learning, and execute the machine learning to build information processing models.

Moreover, in FIG. 1, the client terminal 3a is installed and operated by the user 4a. Similarly, the client terminals 3b and 3c are installed and operated by the users 4b and 4c, respectively. In this embodiment, the client terminals 3a to 3c and the users 4a to 4c are not different from one another in a technical sense, but the client terminal 3a and the user 4a are described as representatives in the following. Thus, when it is not required to distinguish the client terminals 3 and the users 4 from one another, the client terminal 3a is simply referred to as “client terminal 3,” and the user 4a is simply referred to as “user 4.”

In the schematic diagram of FIG. 1, only a representative configuration of the present invention is exemplified for the convenience of description. It is not always required that the overall configuration of the machine learning model determination system 1 be completely the same as the illustrated configuration. For example, the number of the client terminals 3 and the number of the users 4 can be freely selected, and are variable. Moreover, it is not always required that the number of the client terminals 3 and the number of the users 4 match each other. One user 4 may operate a plurality of client terminals 3. Further, it is not always required that the client terminals 3 be devices physically independent of one another, and may be virtual machines which use a so-called cloud computing service or the like. In this case, a plurality of client terminals 3 can be built on physically the same device. Moreover, the same applies to the server 2. It is not always required that the server 2 be an independent device, and may be built as a virtual machine. Thus, physical locations of the server 2 and the client terminals 3 are not limited, and may be distributed to a plurality of devices, and a part or the whole thereof may be installed on the same device in an overlapping manner.

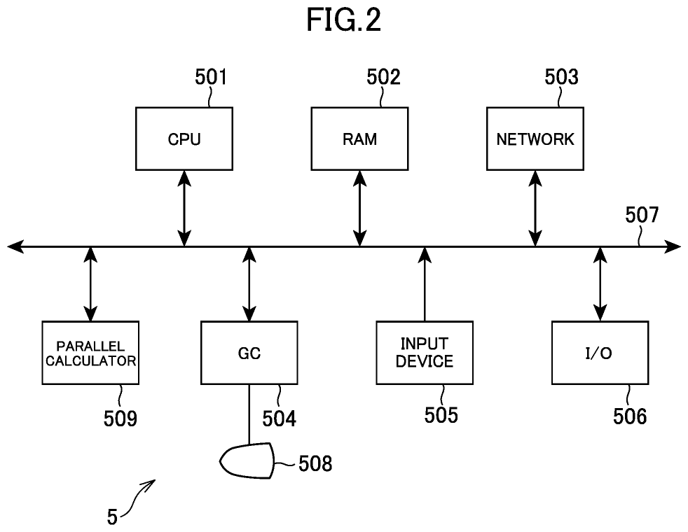

FIG. 2 is a diagram for illustrating an example of a hardware configuration of each of the server 2 and the client terminal 3. FIG. 2 shows a general computer 5, in which a central processing unit (CPU) 501, which is a processor, a random access memory (RAM) 502, which is a memory, an external storage device 503, a graphics controller (GC) 504, an input device 505, and input/output (I/O) 506 are connected by a data bus 507 so that electric signals can be exchanged thereamong. In the computer 5, a parallel calculator 509 may further be connected to the data bus 507 as required. The hardware configuration of the computer 5 described above is merely an example, and another configuration may be employed.

The external storage device 503 is a device in which information can be recorded statically, such as a hard disk drive (HDD) or a solid state drive (SSD). Further, a signal from the GC 504 is output to a monitor 508, such as a cathode ray tube (CRT) or a so-called flat panel display, on which a user visually recognizes an image, and the signal is displayed as an image. The input device 505 is one or a plurality of devices, such as a keyboard, a mouse, and a touch panel, to be used by the user to input information, and the I/O 506 is one or a plurality of interfaces to be used by the computer 5 to exchange information with external devices. The I/O 506 may include various ports for wired connection, and a controller for wireless connection.

The parallel calculator 509 is an integrated circuit provided with a large number of parallel calculation circuits so that large-scale parallel calculation frequently appearing in the machine learning can be executed at high speed. As the parallel calculator 509, it is preferred that a processor for three-dimensional graphics generally known as a graphics processing unit (GPU) be used. Moreover, for example, an integrated circuit designed to be particularly appropriate for the machine learning may be used. Further, when the GC 504 includes a GPU, and this GPU has a calculation performance sufficient for the information processing that uses the machine learning intended to be executed by the user 4, the GPU provided to the GC 504 may be used as the parallel calculator 509 or in addition to the parallel calculator 509.

Computer programs for causing the computer 5 to function as the server 2 or the client terminal 3 are stored in the external storage device 503, and are read out by the RAM 502 and executed by the CPU 501 as required. That is, in the RAM 502, a code which is executed by the CPU 501 to cause the computer 5 to function as the server computer 2 or the client terminal 3 is stored. Such computer programs may be provided by being recorded on an appropriate computer-readable information recording medium such as an appropriate optical disc, magneto-optical disk, or flash memory, or may be provided via the I/O 506 through an external information communication line such as the Internet.

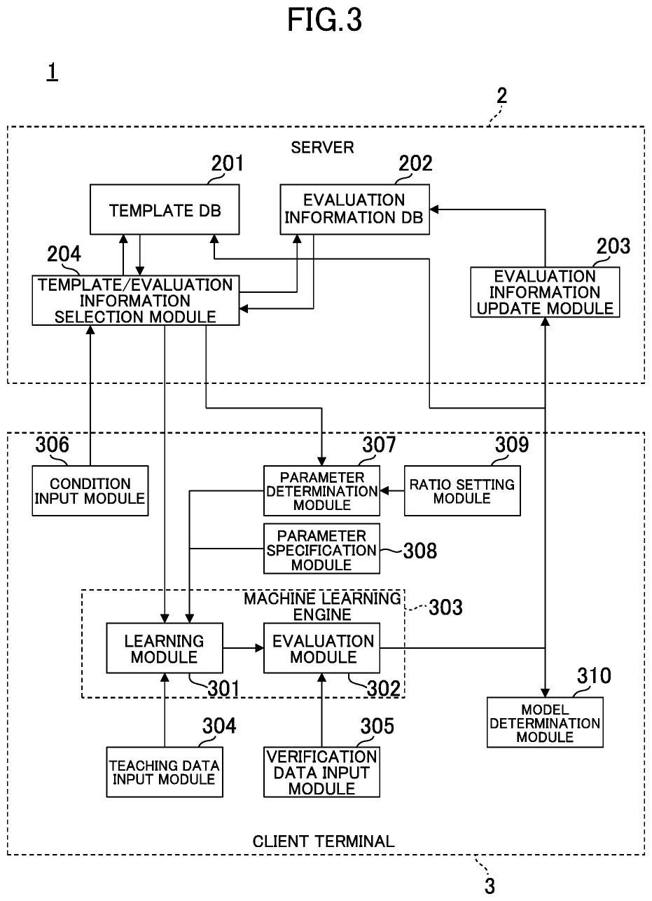

FIG. 3 is a functional block diagram for illustrating a principal configuration of the machine learning model determination system 1 according to this embodiment. A reason for the specific statement of “principal” is that the machine learning model determination system 1 may include an additional configuration other than the configuration of FIG. 3. This additional configuration is not shown in FIG. 3 in order to avoid complicated illustration. This additional configuration is described later.

As illustrated in FIG. 1, the machine learning model determination system 1 includes the plurality of client terminals 3 to be used by the plurality of users, but the representative one of the plurality of client terminals 3 (that is, the client terminal 3a) is illustrated in FIG. 3. Thus, when the plurality of client terminals 3 are connected for communication to the server 2, a plurality of client terminals 3 (not shown) each having a configuration equivalent to that of the client terminal 3 of FIG. 2 exist. Meanwhile, the server 2 is common to the plurality of client terminals 3.

A template database 201 and an evaluation information database 202 are included in the server 2, and store one or a plurality of templates and one or a plurality of pieces of evaluation information corresponding to respective templates, respectively. The template as used herein is information which defines at least a type and forms of input and output of a machine learning model to be used for the machine learning. Moreover, the evaluation information is information on a parameter influencing a learning result of the machine learning and on an evaluation of the learning result of the machine learning for a value of this parameter. A more specific description of the template and the evaluation information is given later. Moreover, an evaluation information update module 203 is included in the server 2, and can update the evaluation information stored in the evaluation information database 202.

A machine learning engine 303 including a learning module 301 and an evaluation module 302, a teaching data input module 304, and a verification data input module 305 are included in the client terminal 3. The teaching data input module 304 inputs specific teaching data which is prepared by the user 4, and is used for a machine learning model to learn for a specific application. The verification data input module 305 similarly inputs specific verification data which is prepared by the user 4, and is used for verification of the machine learning model for which the learning for the specific application has been finished. The teaching data input module 304 and the verification data input module 305 include an appropriate graphical user interfaces (GUIs) and the like, and deliver the specific teaching data and the specific verification data prepared by the user 4 to the machine learning engine 303.

The learning module 301 included in the machine learning engine 303 builds the machine learning model and uses the specific teaching data to execute the learning. In this embodiment, the machine learning model to be used in the learning module 301 is automatically built by the machine learning model determination system 1 itself based on conditions such as an application for which the user 4 uses the machine learning. A mechanism for automatically building the machine learning model by the machine learning model determination system 1 is described later.

Moreover, the evaluation module 302 included in the machine learning engine 303 uses the specific verification data for the machine learning model, which has been built and has been caused to learn in the learning module 301, to evaluate the learning result of the machine learning. This evaluation of the learning result may be executed by inputting a question included in the specific verification data, and comparing an output result thereof with an answer included in the specific verification data. In this embodiment, the evaluation by the evaluation module 302 is based on a correct answer rate (a rate of the output results of the machine learning model matching the answers) in the specific verification data, but this index of the evaluation may be any index that suits a property and the application of the machine learning model to be built. Evaluation indices other than the simple correct answer rate described in this embodiment are independently described later.

As a configuration for building the machine learning model to be used in the learning module 301, the client terminal 3 includes a condition input module 306 and a parameter determination module 307.

First, the condition input module 306 is a portion for the user 4 to input conditions for selecting a template, and may include an appropriate GUI and the like. The conditions for selecting the template are information on the application for which the information processing through machine learning is used, and is information sufficient to specify at least the type and the forms of the input and the output of this machine learning model. More specifically, the conditions include a target of use of the application and formats of input data and output data.

The conditions for selecting the template are transmitted to a template/evaluation information selection module 204 of the server 2. The template/evaluation information selection module 204 selects one or a plurality of templates matching the conditions from the template database 201. Further, the template/evaluation information selection module 204 selects one or a plurality of pieces of evaluation information associated with the selected template from the evaluation information database 202. The selected template is transmitted to the learning module 301 of the client terminal 3, and is used to build machine learning models. The selected evaluation information is transmitted to the parameter determination module 307 of the client terminal, and is used to determine specific values of a parameter.

The parameter determination module 307 determines the specific values of the parameter based on the evaluation information transmitted from the template/evaluation information selection module 204. In this case, the evaluation information transmitted from the template/evaluation information selection module 204 is the evaluation information associated with the selected template so that the template matches the conditions input for the machine learning to be executed and used by the user, and can thus be considered as evaluation information on the machine learning to be executed.

Moreover, the parameter as used herein is various setting values and the like which influence the learning result through the machine learning as described above, and brings about different results depending on specific definition of the parameter even when completely the same teaching data is used for the learning, and completely the same verification data is used to evaluate the learning result. This parameter can be a numerical parameter or can be a selection parameter for selecting one or a plurality of a finite number of options. A plurality of types of parameters usually exist. A representative example of this parameter is a so-called hyperparameter in the machine learning. As parameters other than the hyperparameter, parameters in preprocessing and postprocessing of the machine learning (for example, a type and weight values of a filter for edge extraction processing in image processing) are given.

When the template is used, the machine learning models in the learning module 301 are built by combining the template selected by the template/evaluation information selection module 204 with the specific values of the parameter determined by the parameter determination module 307. Thus, when the template/evaluation information selection module 204 selects “n” templates, and the parameter determination module 307 determines mₖ specific values of the parameter for a selected k-th template, the number of machine learning models to be built is give as below.

$${\sum }_{k = 1}^{\text{?}} {m}_{k}$$

$$\text{?} \text{indicates text missing or illegible when filed}$$

It is considered that a case in which the type and the application of the machine learning model to be determined by this machine learning model determination system 1 are limited to a specific type and a specific application corresponds to a case in which the number of prepared templates is one. In this case, it is not required to select the template and the evaluation information, and hence the template/evaluation information selection module 204 of the server 2 and the condition input module 306 of the client terminal 3 may be omitted.

The evaluation information update module 203 updates, based on the evaluation of the learning result of the machine learning model obtained in the evaluation module 302 of the machine learning engine 303, the evaluation information which has been used to determine the specific value of the parameter to build this machine learning model. Moreover, this machine learning model has been caused to learn through use of the specific teaching data input from the teaching data input module 304, and hence it is considered that the evaluation information update module 203 updates the evaluation information based on the evaluation of the learning result of the machine learning which has used the specific value of the parameter and the specific teaching data.

The evaluations of the learning results of the machine learning models obtained in the evaluation module 302 may be used to update a part of the templates stored in the template database 201. The update of the templates based on the evaluation of the learning result is described later.

Moreover, in the machine learning model determination system 1 according to this embodiment, the client terminal 3 further includes a parameter specification module 308 and a ratio setting module 309. The parameter specification module 308 is used by the user to explicitly specify specific values of the parameter independently of the specific values of the parameter determined by the parameter determination module 307, and may include an appropriate GUI. In the learning module 301 of the machine learning engine 303, in addition to the machine learning models through the specific values of the parameter determined by the parameter determination module 307, machine learning models through the specific values of the parameter specified by the user using the parameter specification module 308 are built. The ratio setting module 309 sets a ratio of preferential selection of, as the plurality of specific values of the parameter determined by the parameter determination module 307, values which have not been used for the machine learning or have been used relatively less frequently for the machine learning, and may include an appropriate GUI. This predetermined ratio is described in detail later.

Further, a model determination module 310 included in the client terminal 3 determines at least one machine learning model from the plurality of machine learning models built in the learning module 301 of the machine learning engine 303 based on the evaluations of the machine learning obtained by the evaluation module 302. As a result, for the application for which the user intends to use the information processing through the machine learning, the plurality of machine learning models are built as the candidates thereof, and the learning through use of the specific teaching data is executed for each candidate. Then, each candidate is verified through use of the specific verification data to obtain the evaluation of each candidate. Consequently, a machine learning model which can obtain the most or more appropriate output for the desired application can be determined.

In the above-mentioned machine learning model determination system 1, description is given while assuming that the parameter determination module 307, the machine learning engine 303, and the model determination module 310 are built on the client terminal 3, but all or a part thereof may be built on the server 2, and the client terminal 3 may receive only the results thereof from the server 2. Moreover, a part of the plurality of client terminals 3 connected to the server 2 may build the parameter determination module 307, the machine learning engine 303, and the model determination module 310 on the client terminal 3. Another part of the plurality of client terminals 3 may build the parameter determination module 307, the machine learning engine 303, and the model determination module 310 on the server 2. The user 4 who can prepare the client terminal 3 having sufficient information processing performance can use the own client terminal 3 to quickly determine the machine learning model, while the user 4 who cannot prepare such a powerful client terminal 3 can cause the server 2 to take over a load of the information processing to determine the machine learning model.

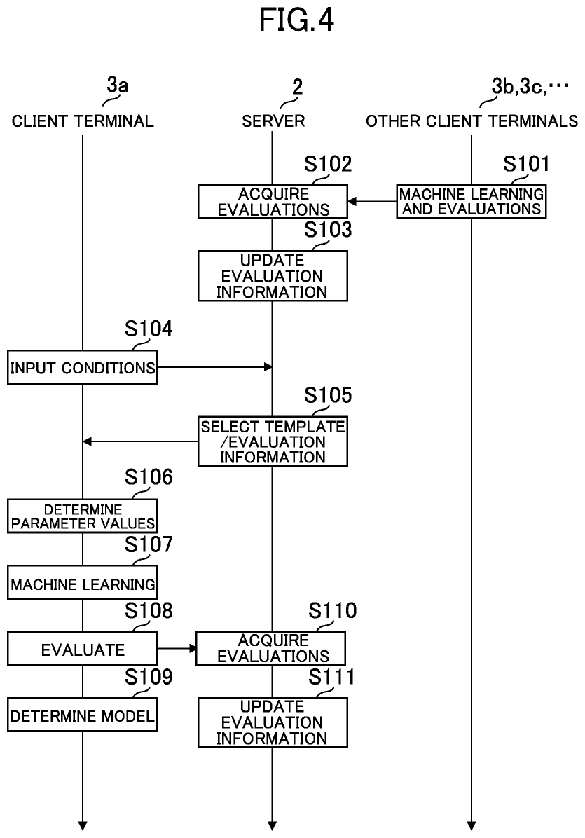

The schematic configuration of the machine learning model determination system 1 according to this embodiment has been described. With reference to FIG. 4, description is now given of a flow of an overall operation of the machine learning model determination system 1 having this configuration and technical significance achieved thereby.

FIG. 4 is a diagram for illustrating a flow of a schematic operation of the machine learning model determination system 1 according to this embodiment. In the figure, the flow is illustrated while the flow is divided into a flow of the client terminal 3a used by the specific user 4a of interest, a flow the server 2, and a flow of one or a plurality of client terminals 3b, 3c, . . . , used by one or a plurality of users 4b, 4c, . . . other than the specific user 4a for the sake of convenience. For description of this flow, FIG. 3 is appropriately referred to. When the function blocks of the machine learning model determination system 1 are referred to, the reference symbols of FIG. 3 are added.

First, it is assumed that, in each of other client terminals 3b, 3c, . . . , a machine learning model suited to a specific application has already been built and has been caused to learn in the learning module 301 by the machine learning engine 303, and the learning result thereof has been evaluated by the evaluation module 302 (Step S101) (however, as described later, it is not required that this evaluation have been made).

The learning results are transmitted to the evaluation information update module 203 of the server 2, and are acquired (Step S102). The evaluation information update module 203 updates the evaluation information stored in the evaluation information DB based on the evaluations (Step S103).

This update of the evaluation information is executed each time the users 4b, 4c, . . . use respective client terminals 3b, 3c, . . . to execute the machine learning, and results thereof are accumulated in the evaluation information DB. The evaluation information is, as described above, information on a parameter influencing the learning result of the machine learning and on the evaluation of the learning result of the machine learning for the value of this parameter. Although not very precise, a brief description is now given of technical significance of this evaluation information in order to facilitate understanding. That is, the evaluation information is information which reflects learning results of past machine learning, to thereby facilitate selection of a value of the parameter used for the machine learning which has obtained a good achievement and a specific value of the parameter close to this value when the parameter determination module 307 determines the specific value of the parameter.

That is, when a certain user 4 uses the client terminal 3 to obtain a good achievement as the machine learning result for a specific value of the parameter, this result is reflected in the evaluation information. After that, when another user 4 uses the client terminal 3 to execute the machine learning through use of the updated evaluation information, the value of the parameter used by the previous user or a value of the parameter close to that value is more likely to be selected.

That is, in the machine learning model determination system 1 according to this embodiment, each user 4 cannot directly know the machine learning models built by other users 4 and the learning result thereof, but can indirectly use whether the learning result is good or bad via the evaluation information, and can efficiently search for and find a machine learning model having a higher accuracy. It is expected that efficiency and an accuracy of this search for the machine learning model increase as more results of the machine learning are obtained by more users 4, and the results are accumulated in the evaluation information. That is, the evaluation information stored in the evaluation information database 202 included in the server 2 has the configuration to be used in common by the plurality of users 4, with the result that quality of the evaluation information is more efficiently increased.

The existence of a plurality of users 4 is not necessarily a prerequisite for this increase in quality of the evaluation information. This increase in quality is an effect achieved by the configuration in which a plurality of machine learning models are constructed and the results of the evaluations are accumulated in the evaluation information. However, the quality of the evaluation information increases more quickly as more results of the machine learning are reflected in the evaluation information, and hence it is effective to adopt the configuration in which the evaluation information is used in common by a plurality of users 4 so that more results of the machine learning are reflected in the evaluation information. Various types of implementation are conceivable for the evaluation information and the update thereof, and a specific example is described in detail later.

In this case, there is required such assumption that, in order to efficiently search for and find a machine learning model having a higher accuracy through the above-mentioned increase in quality of the evaluation, when a value of a parameter employed in a machine learning model which was built by a certain user 4 based on a circumstance specific to this user 4 and has obtained a good achievement is employed in a machine learning model to be built by another user 4 based on another circumstance, the machine learning model to be built is also likely to obtain a good achievement. This assumption is not correct in a strict sense. That is, not only in a case in which an application and a purpose of the machine learning are different among the machine learning models as a matter of course, but also in a case in which the application and the purpose of the machine learning are equivalent, it is not generally guaranteed that, when machine learning models built by employing the same value of the parameter learn based on pieces of teaching data different from one another, and learning results thereof are evaluated based on pieces of verification data different from one another, the evaluations of learning result thereof are equivalent to one another.

However, it has empirically been observed that, in machine learning in which machine learning models and the forms of the input and the output of the machine learning are the same, and the application and the purpose thereof are equivalent, machine learning models built by employing the same parameter or close parameters obtain excellent achievements in many cases even when different pieces of teaching data and verification data are used. Thus, in practice, it is very meaningful to facilitate employment of a value of a parameter which was employed to build a machine learning model having obtained a good achievement in a past case when a machine learning model is built in another new case.

In particular, in the machine learning, an enormous amount of calculation is generally required to build a machine learning model, to execute learning, and to further evaluate a learning result thereof, and hence it is unrealistic to thoroughly search for all possibilities in a vast parameter space. The search by preferentially employing values of a parameter used to build machine learning models having obtained good achievements or values close to the values based on past similar cases is an efficient and practical approach when a machine learning model obtaining a good achievement is to be built in a shorter time and with a smaller amount of calculation.

The above-mentioned similarity of the value of the parameter in the machine learning is observed in a group of machine learning models among which commonality is seen in an application or a purpose, and is not observed or is limited if any in a group of machine learning models without commonality. For example, in a machine learning model which detects a failure of a device based on a current waveform in a positioning mechanism which uses a one-axis servo ball screw system, even when devices are more or less different in manufacturer, model, and load or different in teaching data and verification data, similarity is observed in values of a parameter employed for machine learning models obtaining good achievements. In contrast, even in the case in which a machine learning model detects a failure of the device based on the current waveform in the same one-axis servo ball screw system, when torque control is executed as in a one-axis servo ball screw system used for a press mechanism, it is observed that a value of the parameter appropriate for the machine learning model is different.

As a matter of course, it should be understood that when the type and the forms of the input and the output of a machine learning model to be built are different, a parameter itself required to build the machine learning model is different, and hence the parameter cannot be mutually used. That is, in the machine learning in which the similarity of the value of the parameter in the machine learning can be used, there is a range of the similarity.

As used herein, the template is the information which defines at least the type and the forms of the input and the output of the machine learning model to be used for the machine learning as described above. Although not very precise, a brief description is also now given of technical significance of this template in order to facilitate understanding. That is, the template defines a range of the similarity of the machine learning to be built by the user 4. That is, it is estimated that there is correlation between the achievement and the value of the parameter among machine learning models built based on the common template. Thus, the template is set so that similarity is observed in the value of the parameter among machine learning models built based on this template.

More specifically, the template first defines the type and the forms of the input and the output of the machine learning model to be used for the machine learning. This is because it is considered that a machine learning model different in the type and the forms has a different parameter to be selected in the first place, and hence the template is not common. Further, the template may define the application and the purpose of the machine learning. In the above-mentioned example of the positioning mechanism which uses the one-axis servo ball screw system, a template defining “long short-term memory (LSTM)” as the type of the machine learning model, one-dimensional time series data as the form of the input, an n-dimensional vector as the form of the output, and “position control” and “failure detection” as the application and the purpose is prepared.

The evaluation information is prepared in association with each template. Thus, a machine learning model built by selecting the same template uses the common evaluation information, and hence it is understood that a parameter reflecting past learning results is appropriately selected. In the above-mentioned example of the template, parameters to be determined are roughly as described below.
Parameter (such as time constant) of a filter applied to the input data
The number of hidden layers of the LSTM, and the number of nodes of each layer
Learning rate
Momentum
Number of truncation steps of the backpropagation through time (BPTT)
Gradient clipping value

That is, it is considered that the machine learning model determination system 1 is a system which efficiently and practically obtains, through use of a rational method, practical preferred values of a parameter to be used for a machine learning model built based on a specific template. With reference again to FIG. 4, description is given of a flow until the values of the parameter are obtained and the machine learning model is determined.

When the user 4a newly builds a machine learning model for specific application and purpose, the user 4a inputs conditions relating to this purpose into the condition input module 306 of the client terminal 3 (Step S104). The conditions are transmitted to the server 2, and are used to select a template in the template/evaluation information selection module 204 (Step S105). The conditions input to the condition input module 306 by the user 4a are not always required to be conditions that directly specify the type and the forms of the input data and the output data of the machine learning model defined by the template.

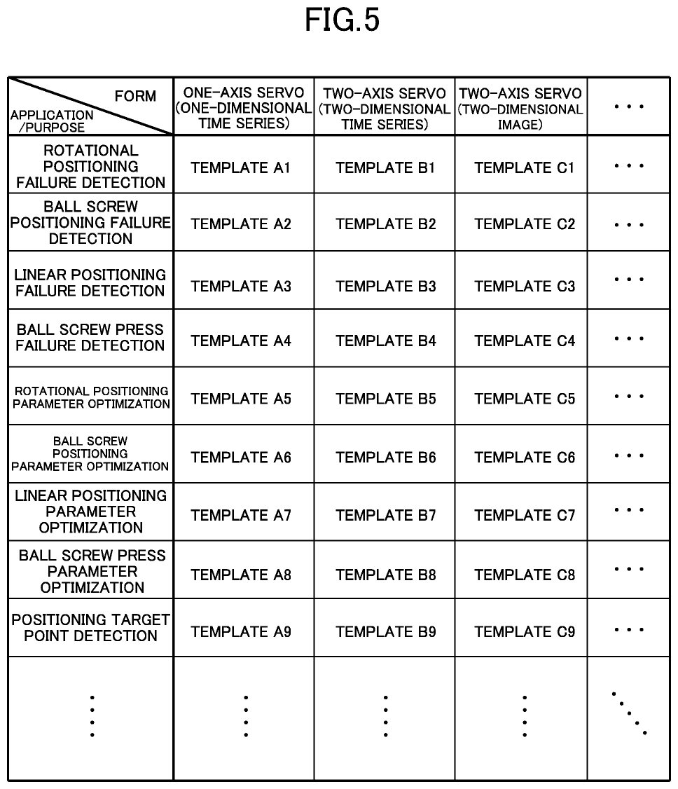

FIG. 5 is a table for showing an example of conditions input to the condition input module 306 by the user 4a and templates defined in accordance with the conditions. In the table of the figure, a form condition for defining the template, that is, a condition for defining the type and the forms of the input data and the output data of the machine learning model is shown in the horizontal direction, and a purpose condition for defining the template, that is, a condition relating to the application and the purpose of the machine learning is shown in the vertical direction so as to distinguish the conditions from each other. However, when the user 4a inputs the conditions, those conditions are not always required to be clarified. A GUI for inputting required conditions in, for example, a so-called wizard form may be employed.

As shown in FIG. 5, when the form condition and the purpose condition are determined, one template is consequently determined. In the table shown in the figure, all templates assigned to respective squares defined by selecting the form condition and the purpose condition are different from one another. When conditions can be treated as similar conditions, a common template may be used. For example, in a case in which such a condition that a one-axis servomotor is used and one-dimensional time series data is input is selected as the form condition, when failure detection in positioning of a rotational drive system (shown as “rotational positioning” in the table) is selected as the purpose condition, a template A1 of the table is determined. When failure detection in positioning of a linear motor drive system (shown as “linear positioning” in the table) is selected as the purpose condition, a template A3 of the table is determined. However, when both of the purpose conditions can be similarly treated, the templates may be a common template.

Moreover, the evaluation information is associated with each template. Thus, the selection of the template by the template/evaluation information selection module 204 based on the input conditions is also considered as selection of the evaluation information.

Moreover, the template/evaluation information selection module 204 may select a plurality of templates depending on the conditions input by the user 4a. For example, when the user 4a inputs the condition that the one-axis servomotor is used and the one-dimensional time-series data is input, and further inputs failure detection in positioning as the condition of the application and the purpose, but does not specify whether the positioning is the rotational positioning, positioning in a ball screw drive system (shown as “ball screw positioning” in the table), or the linear positioning, all of the template A1, a template A2, and the template A3 being possible candidates may be selected. Moreover, there may be provided such a definition that, under a specific condition, a plurality of templates associated with other conditions are selected.

As described above, when the conditions provided to the template/evaluation information selection module 204 by the user 4a are the information on the machine to which the user 4a intends to apply the machine learning and the purpose and the application thereof, even when the user 4a does not have sufficient knowledge on a large number of machine learning models, a template for building an appropriate machine learning model is automatically selected based on the input conditions. It is considered that there is a case in which a plurality of candidates of the machine learning models exist depending on the conditions. In this case, it is only required to select a plurality of templates for building the machine learning models. Each template includes definitions of known machine learning models, and the definitions may indicate architectures of existing machine learning models. For example, the architectures may be AlexNet, ZFNet, ResNET, and the like when the architectures are convolutional neural networks (CNNs), and may be simple RNN, LSTM, Pointer Networks, and the like when the architectures are recurrent neural networks (RNNs). In addition, a convolutional recurrent neural network (CRNN), a support vector machine, and the like are prepared in advance in accordance with a property of the machine learning to be provided to the user 4.

The template selected in the template/evaluation information selection module 204 is read out from the template database 201, and is transmitted to the client terminal 3a.

Moreover, the evaluation information corresponding to the selected template is also read out from the evaluation information database 202, and is transmitted to the client terminal 3a. With reference again to FIG. 4, in the next Step S106, values of the parameter to be used to build the machine learning models are determined by the parameter determination module 307 of the client terminal 3a. Herein, the values of the parameter to be used to build the machine learning models are referred to as “specific values of the parameter.”

Even when only one specific value of the parameter is determined, the machine learning model determination system 1 theoretically functions. However, the parameter determination module 307 determines a large number of specific values, which is usually two or more specific values, of the parameter. One machine learning model is built by applying a specific value of the parameter to a definition of a machine learning model included in a template, and hence the number of determined specific values of the parameter indicates the number of machine learning models to be afterward built by the learning module 301.

This is understood as described below. That is, the parameter is one of various types of setting values and the like which influence the learning result of the machine learning. Thus, even when the learning is executed for the specific values of the parameter through the same teaching data, and learning results thereof are evaluated through the same verification data, the evaluations thereof are different from one another, and superior and inferior results exist. It is generally difficult to accurately predict the superiority and inferiority in advance from the values themselves of the parameter. Thus, a large number of specific values of the parameter are determined. A large number of machine learning models are built based on the specific values of the parameter. Learning results of the large number of machine learning models are evaluated. A finally employed specific value of the parameter, that is, a specific machine learning model is consequently determined.

The number of determined specific values of the parameter depends on computing resources of the client terminal 3a which the user 4a can allow. When a sufficient time and a sufficient calculation performance of the client terminal 3a can be secured, an increase in the number of specific values of the parameter can be allowed. The number is determined in consideration of the allowable time and cost otherwise. This number may suitably be set by the user 4a, and it is considered that the number is several tens to several tens of thousands. However, the number is not particularly limited.

Subsequently, the learning module 301 of the machine learning engine 303 of the client terminal 3a applies the determined specific values of the parameter to the selected template, to thereby build machine learning models. When a plurality of machine learning models are built, specific teaching data input from the teaching data input module 304 is applied to each machine learning model, to thereby execute the machine learning (Step S107).

Specific verification data input from the verification data input module 305 is applied by the evaluation module 302 of the machine learning engine 303 to each machine learning model after the machine learning, to thereby evaluate a result of the machine learning (Step S108). This evaluation may be executed by, as an example, calculating the correct answer rate of the output from the machine learning model with respect to the correct answer prepared in the verification data. Thus, when a plurality of built and learned machine learning models exist, a plurality of evaluations also exist.

The evaluations of the machine learning models are used for the determination of the machine learning model in the model determination module 310 of the client terminal 3a (Step S109). In the model determination module 310, a machine learning model having the highest evaluation, that is, having obtained the highest achievement is simply determined as a model to be employed. Other implementations can be conceived, for example, such implementation that a plurality of machine learning models having higher evaluations are presented as candidates to the user 4a for selection.

Simultaneously, the evaluations of the machine learning are transmitted to the server 2 together with the specific values of the parameter used to build respective machine learning models, and the evaluations are then acquired by the server 2 (Step S110). The transmitted evaluations are used to update the evaluation information on the machine learning models in the evaluation information update module 203 of the server 2 (Step S111). The evaluations transmitted to the server 2 at this time may further be used to update the template stored in the template database 201 as indicated by the arrow of FIG. 3. A relationship between the evaluations of the machine learning and the template is described later.

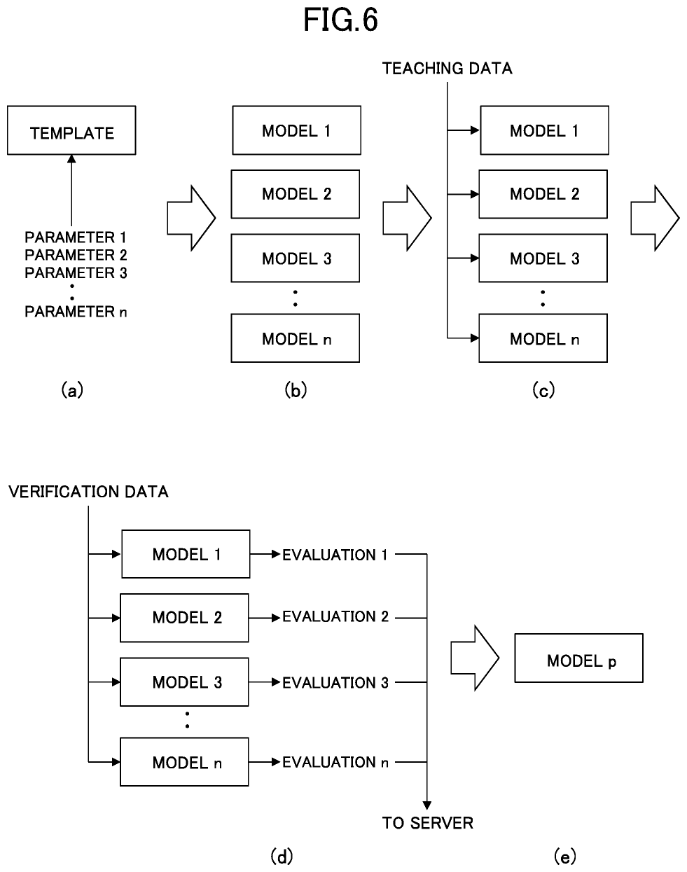

FIG. 6 is a schematic diagram for illustrating the processing executed in Step S107 to Step S111 of the flow of FIG. 4 in line with the machine learning models to be built. In FIG. 6, a state in which the machine learning models are built and a model finally employed is determined in a sequence of part (a) to part (e) of FIG. 6 is schematically illustrated.

Processing steps of part (a) and part (b) of FIG. 6 are processing steps of building the machine learning models in the learning module 301 of the machine learning engine 303 of the client terminal 3a in Step S107. First, in the processing step of part (a) of FIG. 6, one or a plurality of specific values of the parameter, which are “n” parameters of a parameter 1 to a parameter “n” of part (a) of FIG. 6, determined by the parameter determination module 307 are applied to the template selected in the template/evaluation information selection module 204.

This application of the parameter 1 to the parameter “n” to the template is now described as a specific example of the information processing. An object which defines a method for operating data formats and data of the machine learning model is defined in the template. The learning module 301 applies the specific value of the parameter to this object to generate an instance being a dataset of this object on a memory of the client terminal 3.

As a result, a model 1 to a model “n” being “n” machine learning models are generated on the memory of the client terminal 3 as illustrated in part (b) of FIG. 6.

Further, as illustrated in part (c) of FIG. 6, the learning module 301 applies the specific teaching data prepared by the user 4a to each of the generated model 1 to model “n,” to thereby execute the machine learning. A specific method of the machine learning depends on the type of the used machine learning model. As the method of the information processing, when a method for the machine learning is defined in the object being an origin of the model 1 to the model “n,” and the learning module 301 executes this method in the machine learning, it is not required to describe a program for the machine learning for each type of the machine learning model in the learning module 301. Further, such excellent extension capability that a template including a type of a new machine learning model can be suitably added and changed, for example, is provided.

After that, in Step S108, as illustrated in part (d) of FIG. 6, the specific verification data prepared by the user 4a is applied by the evaluation module 302 to each of the learned model 1 to the learned model “n,” and the learning results thereof are then evaluated. Each evaluation is quantitatively executed, and “n” evaluations of an evaluation 1 to an evaluation “n” corresponding to the model 1 to the model “n” are obtained.

The evaluation 1 to the evaluation “n” obtained in the processing step of part (d) of FIG. 6 are transmitted to the server 2 in Step S110, and are used for the update of the evaluation information in Step S111 as already described above. Meanwhile, in Step S109, the model determination module 310 of the client terminal refers to the evaluation 1 to the evaluation “n” to determine a model “p” being a machine learning model having obtained the best achievement as illustrated in part (e) of FIG. 6. The user 4a can set the model “p” determined as described above as the model to be employed, to thereby use the machine learning for the desired application.

As described above, in the machine learning model determination system 1, the user 4a specifies the application for which the user 4a intends to use the machine learning and other conditions, to thereby automatically generate a plurality of candidates of the machine learning model considered as appropriate. The user 4a then automatically executes the learning and the evaluation, and can identify and use the machine learning model having obtained a good achievement. Thus, a skilled engineer familiar with the technology of the machine learning is not required, and the user 4a can build and use an excellent machine learning model. Moreover, the results of the learning and the evaluation are used for the update of the evaluation information. As more machine learning models are built, a probability that an excellent machine learning model is generated increases. Thus, as the use of the machine learning model determination system 1 progresses, a machine learning model which exhibits a good achievement can be obtained in a shorter time and at lower load.

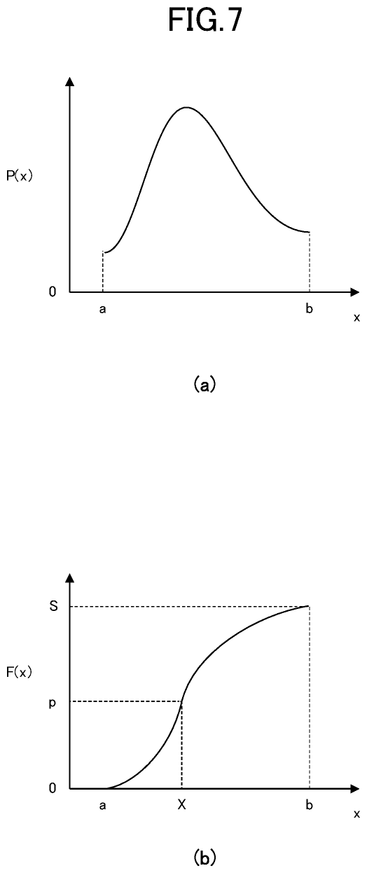

With reference to FIG. 7 to FIGS. 11, description is now given of a specific implementation example of the determination of the specific values of the parameter in the parameter determination module 307. FIG. 7(a) is a conceptual diagram of selection probability information included in the evaluation information associated with the template selected by the template/evaluation information selection module 204.

The selection probability information in this example is a probability density function. That is, “x” assigned to the horizontal axis of FIG. 7(a) is a parameter to be determined. Further, P(x) assigned to the vertical axis is a value of the probability density function of the value of this parameter. A section [a, b] is given as a significant range of the parameter, and hence P(x) is defined in this section. For the convenience of description, the parameter “x” is illustrated as one dimensional in FIG. 7. However, a plurality of parameters may be determined, and hence the parameter “x” may be a vector quantity. The horizontal axis of FIG. 7 indicates a parameter space of any dimension, and the section [a, b] indicates a region in this parameter space.

An integral of the probability density function P(x) is generally 1 in its domain [a, b] as given by the following expression (this state is referred to as the probability density function P(x) being normalized).

However, as described later, the probability density function P(x) included in the evaluation information in this embodiment is not necessarily stored in the normalized form, and is not always required to be normalized.

Incidentally, the parameter determination module 307 determines a specific value X of the parameter included in the section [a, b] in accordance with the probability density function included in the evaluation information. This determination is probabilistically made. When “n” specific values of the parameter are determined as X₁, X₂, X₃, . . . , Xₙ, the specific values of the parameter are different from one another unless accidental coincidence occurs. The distribution of the specific values of the parameter follows the probability density function P(x). As described above, the parameter determination module 307 probabilistically determines the specific values of the parameter based on the evaluation information. Thus, the evaluation information includes the selection probability information indicating the probability that the specific value of the parameter is selected. The probability density function described here is an example of the selection probability information.

A specific method of defining the specific value of the parameter from the selection probability information may be any method. As an example thereof, a method of using a cumulative distribution function is described. FIG. 7(b) is a graph for showing a cumulative distribution function F(x) of the probability density function P(x) of FIG. 7(a). The cumulative distribution function F(x) is also defined in the section [a, b], and is given as follows.

$$F ( x ) = {\int }_{\text{?}}^{\text{?}} P ( \text{?} ) d \text{?}$$

$$\text{?} \text{indicates text missing or illegible when filed}$$

A range thereof is [0, S] when S is given as follows.

$$S = {\int }_{\text{?}}^{\text{?}} P ( x ) dx$$

$$\text{?} \text{indicates text missing or illegible when filed}$$

When P(x) is normalized, S is 1.

In this case, when a random number “p” is generated between 0 to S, and the specific value X of the parameter is determined as a value of “x” at the time when the random number “p” crosses F(x), X follows the probability distribution defined by the probability density function P(x).

When the specific value X of the parameter is determined as described above, a value X corresponding to a large value of the probability density function P(X) is more likely to be selected. A value X corresponding to a small value of the probability density function P(X) is less likely to be selected. Thus, a machine learning model exhibiting a good achievement in a shorter time at lower load is obtained by defining the probability density function P(x) such that a specific value of the parameter having a high likelihood of obtaining a high evaluation as a result of the machine learning is more likely to be selected, and a specific value of the parameter having a high likelihood of not obtaining a high evaluation as a result of the machine learning is less likely to be selected.

However, it is difficult to provide, in advance, a shape of an ideal probability density function P(x). Thus, in the machine learning model determination system 1 according to this embodiment, the probability density function P(x) is caused to approach an ideal shape by using the evaluation of the learning result of the machine learning by the user 4 to successively update the probability density function P(x). That is, as a larger number of learning results of the machine learning by the user 4 are obtained, the probability density function P(x) is updated to such a shape that a specific value of the parameter having a high likelihood of obtaining a high evaluation as a result of the machine learning is more likely to be selected.

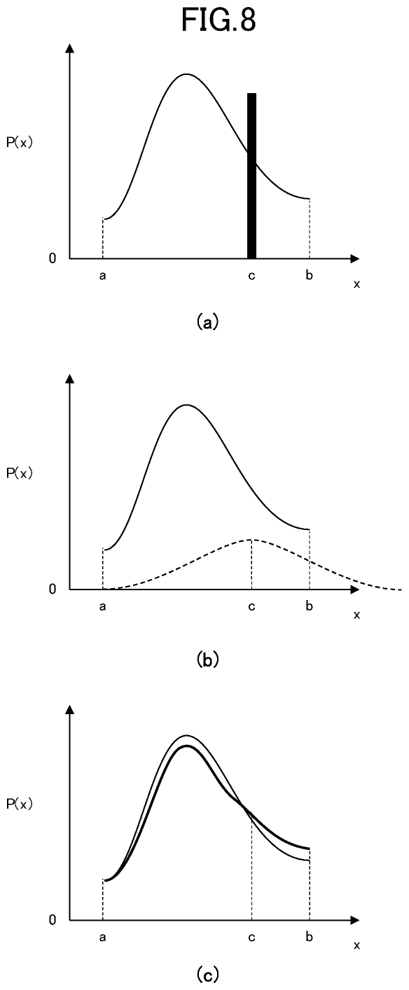

FIG. 8 are schematic graphs for showing an example of the update of the probability density function P(x). FIG. 8(a) shows the probability density function P(x) before the update as the solid line. In this case, it is assumed that a learning result corresponding to a specific value “c” of the parameter determined by using this probability density function P(x) obtains high evaluation. In FIG. 8(a), the fact that the specific value “c” of the parameter obtains the high evaluation is indicated as the black solid vertical bar in order to facilitate understanding. The vertical axis for the probability density function P(x) and the vertical axis for the specific value “c” of the parameter are not necessarily to the same scale.

The evaluation information update module 203 generates an update curve of the probability density function P(x) as indicated as the broken line of FIG. 8(b) based on the evaluation obtained by the specific value “c” of the parameter. In this case, the update curve is a normal distribution centered around “c.” At this time, it is preferred that a value of a variance σ² be appropriately defined in accordance with a magnitude of the section [a, b] of the parameter. Moreover, it is preferred that a weight, that is, a magnitude in a vertical-axis direction of the update curve be adjusted by multiplying an appropriate coefficient “k” corresponding to the evaluation obtained by the specific value “c” of the parameter. That is, it is preferred that, as the evaluation of the result of the machine learning is higher, the probability density function P(x) be changed more.

For example, when the evaluation of the machine learning is based on a correct answer rate “a” for the specific verification data, and a machine learning model having a correct answer rate of 70% or more is affirmatively evaluated, the update curve is given by the following expression.

kN(c,σ²);k=a−0.7

After that, as shown in FIG. 8(c), the probability density function P(x) before the update and the update curve are added to each other in the section [a, b], to thereby obtain a new probability density function P(x) after the update indicated as the thick line. In FIG. 8(c), the probability density function P(x) after the update is normalized, and hence the value of the probability density function P(x) increases near the specific value “c” of the parameter which obtains the high evaluation, and the value of the probability density function P(x) decreases in portions apart from “c.”

In the example of the update curve exemplified above, when the correct answer rate “a” is just 70%, the probability density function P(x) is not updated. When the correct answer rate “a” exceeds 70%, the value of the probability density function P(x) is changed toward a direction of increase for the specific value “c” of the parameter and values in the vicinity thereof. Meanwhile, when the correct answer rate “a” falls below 70%, the value of the probability density function P(x) is changed toward a direction of decrease for the specific value “c” of the parameter and the values in the vicinity thereof (due to a downward convex shape of the update curve). That is, the value of the probability density function P(x) included in the selection probability information is changed toward the same direction for this specific value “c” of the parameter and the values in the vicinity thereof based on the result of the machine learning for the specific value “c” of the parameter.

The reason is for this as follows. When the parameter has a continuous property, it is predicted that influence on the machine learning at the certain specific value “c” of the parameter and influence on the machine learning at values in the vicinity of this specific value “c” have similar properties. As a result, it is predicted that, when a good achievement is obtained for the specific value “c,” a good achievement is also obtained for the values in the vicinity thereof. Conversely, it is predicted that, when a bad achievement is obtained for the specific value “c,” a bad achievement is also obtained for the values in the vicinity thereof.

Thus, the normal distribution is used as the update curve in the description given above, but it is not always required to use the normal distribution. As long as a curve can have influence on the probability density function P(x) after the update in the same direction for the specific value “c” of the parameter and the values in the vicinity thereof, any curve can be selected. Moreover, “curve” herein is a usage in the general sense, and includes a “curve” formed of a straight line. Such a “curve” may be, for example, a curve having a triangular waveform or a curve having a shape of stairs.

The fact that the parameter has the continuous property herein means that different values of the parameter of the same type present a quantitative difference, and it is not required the parameter itself be treated as continuous. As an actual problem, the values of the parameter are treated as a set of discrete values in digital processing performed in a computer. This treatment itself does not have influence on the continuous property of this parameter.

Meanwhile, depending on the parameter, there is considered a case in which a parameter does not have the continuous property, but has the discrete property. The state in which the parameter has the discrete property is considered as a state in which different values of the parameter of the same type present a qualitative difference. A direct relationship is not observed among different values of this parameter. As an example of the discrete parameter, for example, a parameter which specifies a type of calculation processing in the machine learning can be given. Specifically, types of optimizer (types in method, such as momentum, AdaGrad, AdaDelta, and Adam) and types of learning (types in method, such as batch learning, mini-batch learning, and online learning) are representative.

When a parameter has the above-mentioned discrete property, it is considered that correlation does not exist between the specific value “c” of the parameter and another value adjacent to the value “c” (for example, in a case in which the parameter is the above-mentioned parameter which specifies the type of optimizer, when the momentum is assigned to the specific value “c” of the parameter, an optimizer assigned to another value in the vicinity of adjacent to the value “c” can suitably be defined, and it is apparent that correlation does not exist therebetween). For such a parameter, there is no significance for the configuration of changing, based on the evaluation of the machine learning obtained for the specific value “c” of the parameter, the evaluation information on the values of the parameter in the vicinity of the value “c” toward the same direction, and hence this configuration is not considered as appropriate.

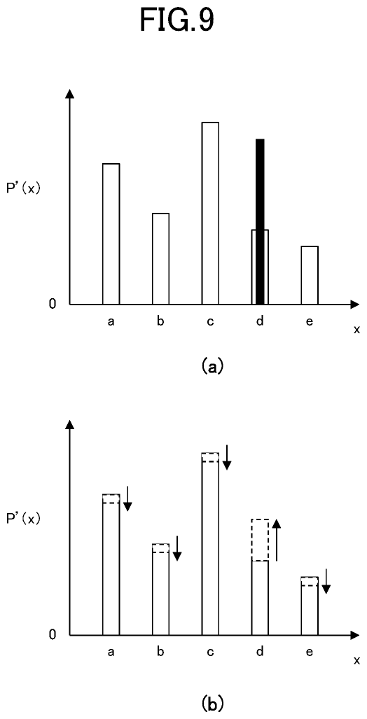

FIG. 9 are schematic graphs for showing an example of the update of the evaluation information for a parameter having the discrete property. It is assumed that the parameter takes, as the value “x” thereof, any one of five values of “a” to “e.” The vertical axis represents a selection probability P′(x) for the value “x,” and is not a continuous function.

FIG. 9(a) shows selection probabilities for the values of “a” to “e” of the parameter as a graph of outlined vertical bars. When P′(x) is normalized, a total sum of P′(a) to P′(e) is 1. It is assumed that the machine learning is executed at the specific value “d” of the parameter, and a high evaluation is obtained. This high evaluation is indicated as the black solid vertical bar of FIG. 9(a) as in the above-mentioned example.

In this case, as shown in FIG. 9(b), the evaluation information update module 203 increases the selection probability P′(x) for the value “d” of the parameter in accordance with the evaluation of the result of the machine learning thereof, and equally decreases the selection probability for each of the other values “a,” “b,” “c,” and “e” of the parameter. FIG. 9(b) shows change amounts of the selection probability P′(x) as broken lines, and shows directions of the changes as the arrows. An example of this update may be given as below through use of the correct answer rate “a” obtained as a result of the machine learning and any coefficient “l” when a change amount of the selection probability P′(x) is ΔP′(x), the total number of parameters is “n,” the parameter used for the machine learning is X_{specific}, and other parameters are xₒₜₕₑᵣ.

$$Δ {P}^{′} ( {x}_{specific} ) = l ( a - 0.7 )$$

$$Δ {P}^{′} ( {x}_{other} ) = \frac{1}{n - 1} Δ {P}^{′} ( {x}_{specific )}$$

In the above-mentioned method, it is only required to appropriately correct the selection probability P′(x) when the selection probability P′(x) for the specific value “x” of the parameter exceeds 1 or falls below 0. Moreover, an upper limit value and a lower limit value may be provided to the value of P′(x). As another example, in place of the method of adding ΔP′(x) to update P′(x), P′(x) may be changed based on a rate corresponding to the evaluation of the learning result or other methods may be used.

The update of the evaluation information by the evaluation information update module 203 in this embodiment is executed independently of the evaluation of the learning result, and hence the update is executed not only when a positive evaluation is obtained, but also when a negative evaluation is obtained. In place of this update, the evaluation information may be updated only when a specific evaluation is obtained. For example, the evaluation information may be updated only when a good achievement is obtained (as an example, when the correct answer rate is 80% or more) as the evaluation of the learning result. In any case, the evaluation information is quickly updated by updating the evaluation information based on each of or a plurality of obtained machine learning results.

As already described above, the shapes of the probability density function P(x) and the selection probability P′(x) included in the evaluation information come to be determined as the evaluation of the result of the machine learning is repeatedly obtained. Thus, at an initial time point when the operation of the machine learning model determination system 1 is started, the shapes of the probability density function P(x) and the selection probability P′(x) are unknown, and any initial shapes may be given to the probability density function P(x) and the selection probability P′(x). As an example of the initial shape, a shape having an equivalent probability over an entire section of the parameter is given.

The above description is given of the case in which only one template is selected by the template/evaluation information selection module 204, and only one piece of the evaluation information is thus selected. However, depending on the machine learning model determination system 1, a plurality of templates and a plurality of pieces of evaluation information corresponding to the templates may be selected. It is possible to search a wider range for machine learning models providing high evaluations of results of the machine learning by allowing the selection of a plurality of templates. Description is now given of a determination method for templates and specific values of parameters to be used to build machine learning models when a plurality of templates and a plurality of pieces of evaluation information are selected by the template/evaluation information selection module 204.

The template/evaluation information selection module 204 selects one or a plurality of templates based on the conditions specified by the user and acquired from the condition input module 306. At this time, as the plurality of templates, when “n” templates of a template 1, a template 2, . . . , and a template “n” are selected as the plurality of templates, in order to build one machine learning model in the learning module 301 of the machine learning engine 303, it is required to determine a template and specific values of the parameter to be used for the building. Various methods are conceivable as the determination method, and examples of the method are now described.

A method described first is a method of selecting one template of the plurality of templates, and then using the evaluation information on this template to determine specific values of a parameter. When this method is employed, it is desired that a score indicating an evaluation of a template itself be assigned to each template.

The score of the template is defined based on an evaluation of a result of the machine learning executed by a machine learning model built by using this template. As a specific example, the highest evaluation of evaluations of results of the machine learning using this template may be employed as the score. When the evaluation is the correct answer rate, the maximum value of the correct answer rates is employed as the score.

Another value may be employed as the score. For example, an average value of a predetermined number of last evaluations of the learning results or an average value of a predetermined number of highest evaluations may be employed as the score. In any case, the score is an index defined based on such a criterion that a higher score is assigned as a high evaluation is more likely to be obtained when this template is used to build a machine learning model based on a past achievement and the machine learning is executed.

This score is linked to each template, and is stored in the template database 201. As an example, the scores are defined as follows.

Template 1: 65

Template 2: 80

. . .

Template “n”: 75

As the method of determining a template to be used, the following methods are conceivable, and any one of the methods may be employed.

(1) Selecting a template having the highest score (highest evaluation)

(2) Probabilistically selecting a template based on the score

In the case of the method (2), it is only required to set a probability that a certain template is selected as follows.

$$\frac{Score of specific template}{Sum of scores of plurality of selected templates}$$

Moreover, it is desired that the score be updated to the newest score reflecting a result of the machine learning each time the result is obtained. Thus, as illustrated in FIG. 3, the evaluation of the result of the machine learning obtained by the evaluation module 302 of the machine learning engine 303 is transmitted to the template database 201, and is used to update the score of the template which has been used to build the machine learning model.

A method described now is a method of assigning a ratio of using each template of a plurality of templates. As described above, the parameter determination module 307 usually determines a plurality of specific values of a parameter in order to build a large number of machine learning models. The number of specific values of the parameter to be determined is defined in accordance with computing resources prepared by the user 4. For example, a number such as 100 or 1,000 is selected.

This number is distributed to the number of machine learning models to be built through use of a certain template in accordance with the score of the selected template. When the distribution is proportional to the scores in this method, a ratio of the numbers of the machine learning models built by using the respective templates in the case of the above-mentioned example of scores is given as “template 1:template 2: . . . :template n=65:85: . . . :n.”

After that, when a certain template is used to build machine learning models, a selection criterion corresponding to this template is used to determine specific values of a parameter, and hence the specific value of the parameter is determined the number of times proportional to the ratio corresponding to the score of each template by using the selection criterion corresponding to this template.

When the score is not assigned to each template, it is only required to equally assign the number of times of determining the specific value of the parameter to each selected template.

A method described lastly is a method of directly determining specific values of a parameter and a template to be used based on a plurality of selection criteria corresponding to a plurality of selected templates. In this method, a plurality of probability density functions P(x) included in the above-mentioned selection criteria are used to probabilistically determine the specific values of the parameter, and templates to be used are accordingly determined.

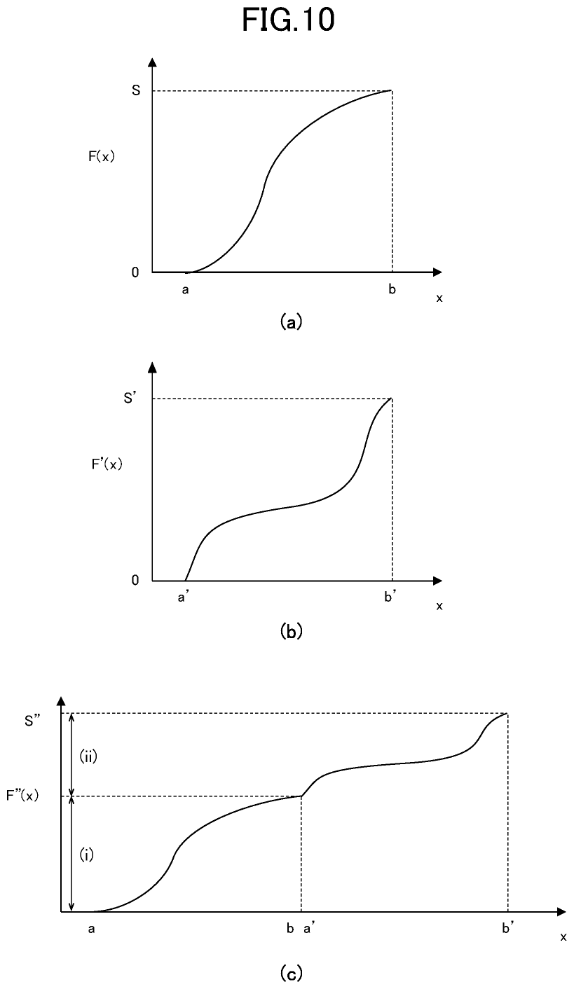

For the convenience of description, it is assumed that a template 1 and a template 2 are selected. FIG. 10 are graphs for showing a determination method for the specific values of the parameter through this method. FIG. 10(a) shows an example of a cumulative distribution function F(x) in the evaluation information on the template 1. FIG. 10(b) shows an example of a cumulative distribution function F′(x) in the evaluation information on the template 2. The cumulative distribution function F(x) is defined in a section [a, b]. The cumulative distribution function F′(x) is defined in a section [a′, b′]. The section [a, b] and the section [a′, b′] may match each other, but are not always required to match each other. Moreover, a terminal value F(b) of the cumulative distribution function F(x) is represented by S. A terminal value F′(b′) of the cumulative distribution function F′(x) is represented by S′. The values S and S′ are not always required to match each other. However, when probability density functions P(x) and P′(x), which are origins of the cumulative distribution functions F(x) and F′(x), respectively, are normalized, S=S′=1.

As shown in FIG. 10(c), the two cumulative distribution functions F(x) and F′(x) are connected so that F(x) and F′(x) are continuous for the parameter “x,” to thereby obtain a connected cumulative distribution function F″ (x). The connected cumulative distribution function F″(x) is a monotonically increasing function defined in a section [a, b′] obtained by connecting the section [a, b] and the section [a′, b′] of the cumulative distribution functions F(x) and F′(x), and a terminal value F″(b′) is represented by S″.

In this case, S″ may simply be set to S+S′. However, when the score is assigned to each of the selected templates, it is preferred that widths of ranges corresponding to the original cumulative distribution functions F(x) and F′(x) in the connected cumulative distribution function F″(x) correspond to the scores. For example, it is only required to set a ratio between a width (i) of the range of the cumulative distribution function F(x) in the connected cumulative distribution function F″(x) of FIG. 10(c) and a width (ii) of the range of the cumulative distribution function F′(x) in the connected cumulative distribution function F″(x) to a ratio between the scores of the respective corresponding templates.

Specifically, when the score of the template 1 is 80 and the score of the template 2 is 60, the ranges are adjusted so that “(i):(ii)=80:60” is achieved. The cumulative distribution functions F(x) and F′(x) are then connected to obtain the connected cumulative distribution function F″(x).

After that, it is only required that, in the parameter determination module 307, a random number be generated in the range of from 0 to S″, an intersection with the connected cumulative distribution function F″(x) be obtained, to thereby determine a specific value of the parameter, and a template to be used be simultaneously selected in accordance with the original cumulative distribution function F(x) or F′(x) to which this specific value of the parameter belongs.

With this method, a specific value of a parameter is probabilistically determined across a plurality of templates. Moreover, a probability that each template and a specific value of a parameter belonging to this template are determined corresponds to the score assigned to this template. When a score is not assigned to a template, it is only required that the widths of the ranges of the respective cumulative distribution functions F(x) forming the connected cumulative distribution function F″(x) be equal to one another.

The machine learning model determination system 1 can use the above-mentioned various methods to select the template stored in the template database 201, can determine a specific value of a parameter based on the evaluation information associated with the selected template, can build a machine learning model, and can evaluate a learning result thereof. After that, the evaluation information is repeatedly updated based on the evaluation of this learning result, and it is expected that the accuracy of the determination of the value of the parameter continuously increase.

Incidentally, as described above, it is difficult to predict the evaluation of the learning result directly from the value of the parameter in many cases. The reason for this is as follows. It is considered that, for a specific value of the parameter which has been used frequently to repeatedly build machine learning models by the machine learning model determination system 1 and values in the vicinity thereof, evaluations of the results of the machine learning are rationally predicted at a certain degree. However, it is considered that other values, that is, a value which has not been used or has less frequently been used as a specific value of the parameter and values in the vicinity thereof often mean that the evaluations of the results of the machine learning cannot be predicted.

Moreover, as described above, the machine learning model determination system 1 updates the evaluation information so that the specific value of the parameter and the values in the vicinity thereof are more likely to be selected based on the results of the machine learning which have already been obtained. For a specific value of the parameter which has not been used or has less frequently been used and values in the vicinity thereof, the probability of the determination for building machine learning models decreases. As a result, when a specific value of the parameter which obtains a high evaluation higher than a certain level is once found, it is predicted that a value of the parameter different from this value comes to be less likely to be selected.

However, it is difficult to predict the relationship between the value of the parameter and the evaluation of the result of the machine learning, and hence there still exists a possibility that, for a specific value of the parameter which has not been used or has less frequently been used and values in the vicinity thereof, a high evaluation is obtained as a result of the machine learning. Thus, it is desired that the machine learning model determination system 1 have a configuration capable of generating a machine learning model in even such a region of the parameter, and evaluating a result thereof.

Thus, as illustrated in FIG. 3, the machine learning model determination system 1 according to this embodiment includes the ratio setting module 309. The ratio setting module 309 defines a predetermined ratio. The parameter determination module 307 preferentially selects, at this predetermined ratio, values which have not been used for the machine learning or have been used relatively less frequently for the machine learning out of a plurality of specific values of a parameter determined by the parameter determination module 307.

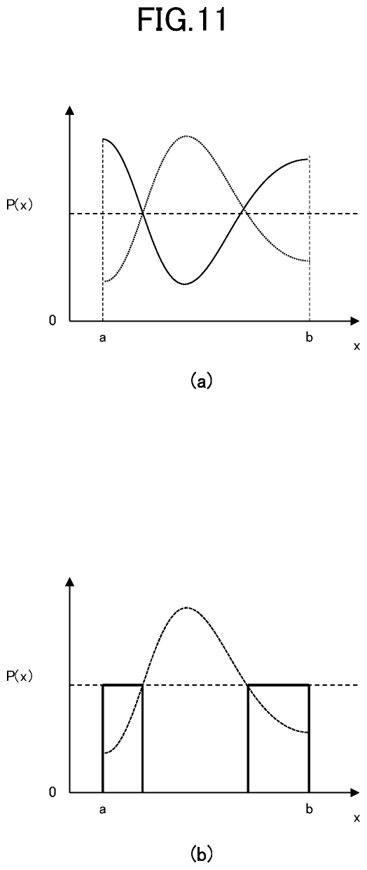

Various methods can be conceived for the parameter determination module 307 to determine specific values of a parameter which have not been used for the machine learning or have been used relatively less frequently for the machine learning. Such a method may be a method exemplified in FIG. 11. FIG. 11 (a) is a graph for showing an example of this method. In this method, the probability density function P(x) included in the evaluation information associated with the template selected by the template/evaluation information selection module 204 is not directly used, but is inverted.

In FIG. 11(a), the original probability density function P(x) included in the evaluation information is indicated as the dotted line. When the original probability density function P(x) is inverted about any value of the probability density indicated as the broken line, a new probability density function indicated as the solid line is obtained. When this new probability density function is used in place of the original probability density function P(x), a value of the parameter having a low probability of the selection in the original probability density function P(x) is more likely to be selected, while a value of the parameter having a high probability of the selection in the original probability density function P(x) is less likely to be selected. Moreover, a value of the parameter having a low probability of the selection in the original probability density function P(x) is considered as a value which has not been used or has less frequently been used as a specific value of the parameter or a value in the vicinity thereof. Thus, it is possible to preferentially select the value which has not been used or has been used relatively less frequently as a specific value of the parameter in the machine learning by using this new probability density function to determine a specific value of the parameter.

Any value of the probability density indicated as the broken line of FIG. 11(a) may be set as a fixed value, an average value of the original probability density function P(x), or a value obtained by multiplying the maximum value by a predetermined coefficient (for example, 0.5).

As another example, a method of FIG. 11(b) may be used. In this method, the selection probability is equally assigned to sections of the parameter “x” in which the value of the original probability density function P(x) is lower than any value of the probability density indicated by a broken line of FIG. 11 (b). In FIG. 11 (b), the selection probability after the assignment is indicated as the solid lines. Also with this method, it is possible to preferentially select a value which has not been used or has been used relatively less frequently as a specific value of the parameter in the machine learning for the same reason as that in the case described with reference to FIG. 11(a). Moreover, also in this method, any value of the probability density indicated as the broken line may be set as a fixed value, the average value of the original probability density function P(x), or a value obtained by multiplying the maximum value by a predetermined coefficient (for example, 0.3).

The ratio setting module 309 sets the ratio of the use of the above-mentioned method of preferentially selecting a value which has not been used or has been used relatively less frequently for the machine learning for the determination of specific values of the parameter. In this case, it is considered that a value of the parameter which has not been used or has been used relatively less frequently for the machine learning may obtain a high evaluation of the result of the learning thereof, but this is not often the case. Meanwhile, it is considered that the value of the parameter which has already been used for the machine learning, and has obtained a high evaluation and values in the vicinity thereof are highly likely to obtain a high evaluation as in the past example. Thus, it is generally considered that specific values of the parameter are mostly determined by the general method, that is, the method of not using the method of preferentially selecting a value which has not been used or has been used relatively less frequently for the machine learning, and are partially determined by the method of preferentially selecting a value which has not been used or has been used relatively less frequently for the machine learning.

This ratio is determined depending on an amount of computing resources which can be used for the method of preferentially selecting a value which does not necessarily highly possibly obtain a high evaluation as a result of the machine learning, and has not been used or has been used relatively less frequently for the machine learning. As one method, this ratio may be artificially defined by the user 4. In this case, the user 4 uses an appropriate GUI of the ratio setting module 309 to specify this ratio as, for example, 5%.

As another method, this ratio may be set in accordance with the number of specific values of the parameter determined by the parameter determination module 307. It is preferred that this ratio become larger as the number of specific values of the parameter to be determined becomes larger. As a specific example, when the number of specific values of the parameter to be determined is 100, the ratio is 5%, when the number is 1,000, the ratio is 10%, and when the number is 10,000, the ratio is 20%.

The reason for this is as follows. It is considered that even in a case in which the usual method is used to determine the specific values of the parameter, when a certain number of specific values of the parameter used for the machine learning do not exist, a probability that a machine learning model obtaining a sufficiently high evaluation is acquired is low. Thus, when the number of specific values of the parameter to be determined is small, it is required to secure a sufficient number of specific values of the parameter determined by the usual method. Meanwhile, when the number of specific values of the parameter to be determined is large, it is considered that the probability that a machine learning model obtaining a sufficiently high evaluation is acquired by the usual method is high. Thus, there exists room for using the method of preferentially selecting a value which has not been used or has been used relatively less frequently for the machine learning, and the number of specific values of the parameter determined by this method can be increased.

Moreover, the ratio setting module 309 may allow the user 4 to select any one of the above-mentioned two methods. That is, the user 4 may freely select the method of artificially setting the above-mentioned ratio or the method of setting the ratio in accordance with the number of specific values of the parameter to be determined.

With the above-mentioned configuration, the machine learning model determination system 1 comes to more efficiently and more precisely determine a machine learning model obtaining a good achievement as the plurality of users 4 more use the client terminals 3 to build machine learning models to be used for respective applications.

However, from a converse point of view, when the users 4 do not build and verify machine learning models, the evaluation information stored in the evaluation information database 202 of the server 2 is not updated, and hence the efficiency and the accuracy of building machine learning models by the machine learning model determination system 1 do not change. In this case, the communication between the client terminals 3 and the server 2 is not executed, and the server 2 does not particularly have information processing to be executed relating to at least the machine learning model determination system 1.

Thus, when a load of processing executed by the server 2 is low, that is, the computing resources are surplus, the server 2 may have a configuration of updating the evaluation information through use of the computing resources by only the server 2 without intermediation of the users 4 and the client terminals 3.

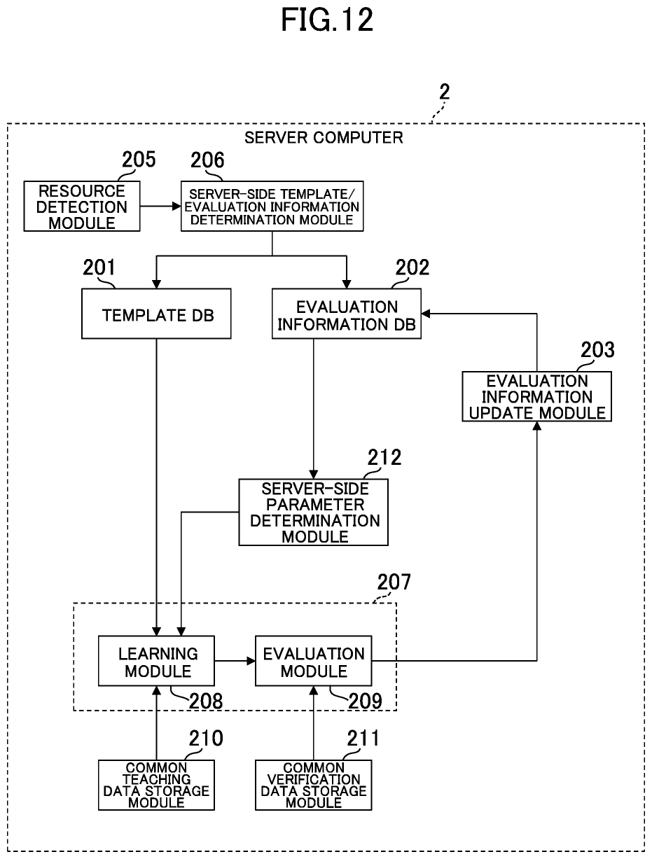

FIG. 12 is a functional block diagram for illustrating a schematic configuration of the server 2 having the configuration of solely updating the evaluation information.

In this configuration, the template database 201, the evaluation information database 202, and the evaluation information update module 203 are the same as the components of the server 2 in the machine learning model determination system 1 of FIG. 3, and are as already described above.

The server 2 further includes a resource detection module 205. This resource detection module 205 detects the surplus computing resources of the server 2, and detects a state in which the load on the server 2 is less than a threshold value set in advance, and the server 2 has room of the calculation processing sufficient for updating the evaluation information solely.

When the resource detection module 205 detects that the server 2 has sufficient computing resources, a server-side template/evaluation information determination module 206 determines any one of the templates stored in the template database 201 and simultaneously determines evaluation information corresponding to the determined template. The template selected in this determination is a template for which common teaching data and common verification data described later are prepared. When a plurality of applicable templates exist, the templates may be selected probabilistically or in a sequence.

The server-side parameter determination module 212 determines specific values of a parameter based on the selected evaluation information. This server-side parameter determination module 212 has a function equivalent to that of the parameter determination module 307 of the client terminal 3 described above. The server-side parameter determination module 212 executes the same operation.

Machine learning models are built in a learning module 208 of a server-side machine learning engine 207 based on the selected template and the determined specific values of the parameter. After that, machine learning is executed through use of the common teaching data prepared and stored in advance in a common teaching data storage module 210 of the server 2.

The common teaching data is not always required to be a single piece of data for learning, and may be a plurality of pieces thereof. Common teaching data appropriate for the machine learning models built through use of the selected template is selected. When a plurality of pieces of appropriate learning data exist, it is only required to suitably select one set thereof.

A result of the machine learning is evaluated in an evaluation module 209 of the server-side machine learning engine 207 through use of the common verification data prepared and stored in advance in a common verification data storage module 211 of the server 2. Also in the case of the common verification data, the common verification data is not always required to be a single piece of data for verification, and may be a plurality of pieces thereof. Common verification data appropriate for the machine learning models built through use of the selected template is selected.

The server-side machine learning engine 207, the learning module 208, and the evaluation module 209 described above have functions equivalent to the functions of the machine learning engine 303, the learning module 301, and the evaluation module 302 of the client terminal 3, and execute the same operations as those thereof. Moreover, the common teaching data and the common verification data may be prepared by an administrator of the server 2, or specific teaching data and specific verification data used to obtain machine learning models appropriate for a specific application of the user 4 who uses the machine learning model determination system 1 may be used as the common teaching data and the common verification data after permission from the user 4 is obtained. In this case, the machine learning model determination system 1 according to this embodiment is configured such that the user 4 cannot access the common teaching data and the common verification data stored in the common teaching data storage module 210 and the common verification data storage module 211, respectively, and the common teaching data and the common verification data provided by a certain user 4 cannot be acquired by other users 4.

The evaluation of the result of the machine learning obtained by the evaluation module 209 is used by the evaluation information update module 203, and is used to update the evaluation information stored in the evaluation information database 202.

As apparent from the description given above, in the server 2 of FIG. 12, the series of processing steps including the selection of a template and evaluation information, the determination of specific values of a parameter, the building and the learning of machine learning models, the evaluation of learning results, and the update of the evaluation information based on the evaluation of the learning results, which are performed through the mutual communication between the server 2 and the client terminal 3 in the configuration of FIG. 3, can be executed solely by the server 2. When a surplus exists in the computing resources of the server 2, this series of processing steps is executed by using the surplus.

With the server 2 having the configuration as described above, the surplus computing resources are effectively used to update the evaluation information, thereby being capable of more efficiently and more precisely building and selecting machine learning models without an additional cost such as preparation of a computer having a high computing performance for the update of the evaluation information and without influence on the usual information processing by the server 2.

Incidentally, in the description given above, as an example of the evaluation in the evaluation module 302 of the machine learning engine 303 of the client terminal 3 and the evaluation module 209 of the server-side machine learning engine 207 of the server 2, the correct answer rate for the verification data (common verification data in the case of the evaluation module 209 of the server-side machine learning engine 207) is directly used.

Meanwhile, as the evaluation of the result of the machine learning in the evaluation module 302 and the evaluation module 209, an index that takes a load of the calculation and the inference by the built machine learning model into consideration may be used.

A reason for the consideration of the load of the calculation and the inference for the evaluation of the result of the machine learning is as follows. That is, when the user 4 uses a machine learning model for a specific application, and can prepare a computer having a sufficient calculation performance, it is considered that a higher accuracy of the result of this machine learning model is simply better. In this case, it is not so required to consider the load of the calculation and the inference for the evaluation of the result of the machine learning.

However, it is often the case that there is a trade-off relationship between the calculation performance of the computer and the cost and various conditions such as an installation condition of the computer. Thus, a computer having a sufficient calculation performance cannot always be used for an intended application of the user 4.

Moreover, of parameters influencing the result of the machine learning, there exist parameters which influence the load of the calculation and the inference of the finally obtained machine learning model, such as the number of hidden layers and the number of nodes of each layer of a neural network. As a result, there is assumed a case in which the machine learning models built and caused to learn by the machine learning model determination system 1 include both of a machine learning model which attains the highest accuracy of the result but has a high load of the calculation and the inference and a machine learning model which attains a slightly inferior accuracy of the result but has a low load of the calculation and the inference.

In this case, when a difference in accuracy of the result is not practically different for the application intended by the user 4 between the two models, the machine learning model having the low load of the calculation and the inference is sometimes determined as being better as a whole. In this case, it is considered that use of an index that takes the load of the calculation and the inference into consideration for the evaluation of the result of the machine learning is appropriate.

An example of such an index I may be defined, for example, as given below, where “a” is an index (for example, the correct answer rate for the verification data) relating to the accuracy of the result of the machine learning, L is the load of the calculation and the inference of a built machine learning model, and “m” and “n” are weighting coefficients.

I=ma−nL

Moreover, the method of the evaluation of the result of the machine learning may vary depending on the application for which the machine learning model is to be used. Thus, as the index of the evaluation of the result of the machine learning in the evaluation module 302 and the evaluation module 209, instead of a single index, indices of the evaluation different for each template may be used.

It should be understood by those skilled in the art that various modifications, combinations, sub-combinations and alterations may occur depending on design requirements and other factors insofar as they are within the scope of the appended claims or the equivalents thereof.

1. A machine learning model determination system, comprising at least one server and at least one client terminal which are connected to an information communication network, and are enabled to communicate with each other,
the at least one server comprising a central processing unit and a memory which are configured to:
store evaluation information which is information regarding an evaluation of a learning result of machine learning for a value of a parameter, the parameter influencing the learning result of the machine learning; and
update the evaluation information based on a specific value of the parameter and an evaluation of a learning result of the machine learning through a use of specific teaching data,
the at least one client terminal comprising a central processing unit and a memory which are configured to:
input the specific teaching data; and
input specific verification data,
wherein the central processing unit and the memory of the at least one server and/or the at least one client terminal are further configured to:
determine the specific value of the parameter based on the evaluation information on the machine learning to be executed;
execute learning for a machine learning model formed based on the specific value of the parameter through use of the specific teaching data; and
evaluate, through use of the specific verification data, a learning result of the machine learning of the learned machine learning model.

2. The machine learning model determination system according to claim 1,
wherein the central processing unit and the memory of the at least one server and/or the at least one client terminal are further configured to:
determine a plurality of specific values of the parameter;
build the machine learning model for each of the plurality of specific values of the parameter;
evaluate the learning result of the machine learning for each of a plurality of the built machine learning models; and
determine at least one machine learning model from the plurality of the machine learning models based on the evaluations of the learning results of the machine learning.

3. The machine learning model determination system according to claim 2, wherein the central processing unit and the memory of the at least one server are further configured to update the evaluation information based on each of the learning results of the machine learning acquired for the plurality of the machine learning models.

4. The machine learning model determination system according to claim 2,
wherein the evaluation information includes selection probability information indicating a probability of selection of the specific value of the parameter, and
wherein the central processing unit and the memory of the at least one server and/or the at least one client terminal are further configured to probabilistically determine the specific value of the parameter based on the selection probability information.

5. The machine learning model determination system according to claim 4, wherein the central processing unit and the memory of the at least one server are further configured to change a value of the selection probability information on the specific value and a value of the selection probability information on a value in a vicinity of the specific value in the selection probability information toward a same direction based on a result of the machine learning for the specific value of the parameter.

6. The machine learning model determination system according to claim 2, wherein the central processing unit and the memory of the at least one server and/or the at least one client terminal are further configured to preferentially select, as a predetermined ratio of the specific values, values which have not been used for the machine learning or have been used relatively less frequently for the machine learning out of the plurality of specific values of the parameter.

7. The machine learning model determination system according to claim 6, wherein the central processing unit and the memory of the at least one client terminal are further configured to artificially set the predetermined ratio.

8. The machine learning model determination system according to claim 6, wherein the central processing unit and the memory of the at least one server are further configured to set the predetermined ratio in accordance with a number of specific values of the parameter determined.

9. The machine learning model determination system according to claim 1,
wherein the central processing unit and the memory of the at least one server are further configured to:
store common teaching data;
store common verification data;
determine the specific value of the parameter based on the evaluation information on the machine learning to be executed in accordance with a load on the at least one server;
execute learning for a machine learning model formed based on the specific value of the parameter through use of the common teaching data;
evaluate, through use of the common verification data, a learning result of the machine learning of the learned machine learning model; and
update the evaluation information based on the specific value of the parameter and the learning result of the machine learning through use of the common teaching data.

10. The machine learning model determination system according to claim 1,
wherein the central processing unit and the memory of the at least one server are further configured to store a template for defining at least a type and form of input and output of the machine learning model to be used for the machine learning,
wherein the central processing unit and the memory of the at least one client terminal are further configured to input a condition for selecting the template,
wherein the central processing unit and the memory of the at least one server and/or the at least one client terminal are further configured to select one or a plurality of templates from a template database based on the condition, and to select one or a plurality of pieces of evaluation information on the selected one or plurality of templates from the evaluation information database,
wherein the central processing unit and the memory of the at least one server are further configured to store the evaluation information for each template,
wherein the central processing unit and the memory of the at least one server and/or the at least one client terminal are further configured to form the machine learning model based on the specific value of the parameter and the selected one or plurality of templates, and
wherein the central processing unit and the memory of the at least one server are further configured to update the evaluation information on the selected one or plurality of templates.

11. The machine learning model determination system according to claim 10,
wherein the central processing unit and the memory of the at least one server and/or the at least one client terminal are further configured to:
select the one or the plurality of templates based on the condition; and
determine the template to be used and the specific value of the parameter based on the plurality of pieces of evaluation information on the selected plurality of templates.

12. The machine learning model determination system according to claim 1, wherein the central processing unit and the memory of the at least one server and/or the at least one client terminal are further configured to evaluate the learning result of the machine learning based on an index that takes a calculation load on the built machine learning model into consideration.

13. A machine learning model determination method to be performed through an information communication network, the machine learning model determination method comprising:
determining a specific value of a parameter based on evaluation information on machine learning which is to be executed, and is information on an evaluation of a learning result of machine learning for a value of the parameter, the parameter influencing the learning result of the machine learning;
forming a machine learning model based on the specific value of the parameter;
executing learning of the machine learning model through use of specific teaching data;
evaluating a learning result of the machine learning of the learned machine learning model through use of specific verification data; and
updating the evaluation information based on the specific value of the parameter and the evaluation of the learning result of the machine learning.

14. The machine learning model determination method according to claim 13,
wherein a plurality of specific values of the parameter are determined,
wherein the machine learning model is built for each of the plurality of specific values of the parameter, and
wherein the machine learning model determination method further comprises:
evaluating the learning result of the machine learning for each of a plurality of the built machine learning models; and
determining at least one machine learning model from the plurality of the machine learning models based on the evaluations of the learning results of the machine learning.

15. A machine learning model determination system, comprising:
at least one server and at least one client terminal which are connected to an information communication network, and are enabled to communicate with each other;
an evaluation information database which is included in the at least one server, and is configured to store evaluation information which is information regarding an evaluation of a learning result of machine learning for a value of a parameter, the parameter influencing the learning result of the machine learning;
an evaluation information update means which is included in the at least one server, and is configured to update the evaluation information based on a specific value of the parameter and an evaluation of a learning result of the machine learning through a use of specific teaching data;
a teaching data input means which is included in the at least one client terminal, and is configured to input the specific teaching data;
a verification data input means which is included in the at least one client terminal, and is configured to input specific verification data;
a parameter determination means configured to determine the specific value of the parameter based on the evaluation information on the machine learning to be executed; and
a machine learning engine which includes a learning module configured to execute learning for a machine learning model formed based on the specific value of the parameter through use of the specific teaching data, and an evaluation means configured to evaluate, through use of the specific verification data, a learning result of the machine learning of the learned machine learning model.
